(19) United States
(12) Patent Application Publication
(10) Pub. No.: US 2019/0184809 A1
(43) Pub. Date: Jun. 20, 2019

(54) ELECTRIC HYBRID POWERTRAINS HAVING A BALL-TYPE CONTINUOUSLY VARIABLE TRANSMISSION

(71) Applicant: Dana Limited, Maumee, OH (US)

(72) Inventors: Jeffrey M. David, Cedar Park, TX (US); Travis J. Miller, Cedar Park, TX (US)

(21) Appl. No.: 16/223,350

(22) Filed: Dec. 18, 2018

Related U.S. Application Data
(60) Provisional application No. 62/599,861, filed on Dec. 18, 2017.

(51) Int. Cl. B60K 6/543; F16H 37/08; B60K 6/365; B60K 6/44

(52) U.S. Cl. CPC B60K 6/543; B60K 6/44; B60K 6/365; F16H 37/086

(57) ABSTRACT

Regular series-parallel hybrid electric powertrains are two-motor HEV propulsion systems mated with a planetary gear, and most mild or full parallel hybrid systems are single motor systems with a gearbox or continuously variable transmission coupled with an electric machine. Coupling a ball-type continuously variable planetary (CVP), such as a VariGlide®, with one electric machine enables the creation of a parallel HEV architecture with the CVP functioning as a continuously variable transmission, and the motor providing the functionality of electric assist, starter motor capability, launch assist and regenerative braking. Two motor variants provide series-parallel hybrid electric vehicle (HEV) architectures. Embodiments disclosed herein, coupled with a hybrid supervisory controller that chooses the path of highest efficiency from engine to wheel, leads to the creation of a hybrid powertrain that are capable of operating at the best potential overall efficiency point in any mode and also provide torque variability.

### RELATED APPLICATION

This application claim priority to and the benefit from U.S. Provisional Application Ser. No. 62/599,861 filed on Dec. 18, 2017 which is incorporated herein by reference.

### BACKGROUND

Hybrid vehicles are enjoying increased popularity and acceptance due in large part to the cost of fuel and greenhouse carbon emission government regulations for internal combustion engine vehicles. Such hybrid vehicles include both an internal combustion engine as well as an electric motor to propel the vehicle.

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed ratio of the hybrid vehicle design.

These fixed ratio designs have many disadvantages, for example the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed speed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that improve the efficiency of hybrid vehicles.

Regular series-parallel hybrid electric powertrains (powersplit eCVT) are two-motor hybrid electric (HEV) propulsion systems mated with a planetary gear, and most mild or full parallel hybrid systems are single motor systems with a gearbox or continuously variable transmission coupled with an electric machine. Coupling a ball-type continuously variable planetary (CVP), such as a VariGlide®, with one electric machine enables the creation of a parallel HEV architecture with the CVP functioning as a continuously variable transmission, and the motor providing the functionality of electric assist, starter motor capability, launch assist and regenerative braking. The dual motor variant opens up the possibility of a series-parallel HEV architecture. Embodiments disclosed herein, coupled with a hybrid supervisory controller that chooses the path of highest efficiency from engine to wheel, provides a means to optimize the operation of the engine and motor/generator, thereby providing a hybrid powertrain that will operate at the best potential overall efficiency point in any mode and also provide torque variability, thereby leading to the best combination of powertrain performance and fuel efficiency that will exceed current industry standards especially in the mild-hybrid and parallel hybrid light vehicle segments.

### SUMMARY

Provided herein is a powertrain including: a first motor/generator; a second motor/generator; an engine; a continuously variable planetary transmission (CVP) having a plurality of balls, each ball provided with a tiltable axis of rotation, each ball in contact with a first traction ring assembly and a second traction ring assembly, and each ball operably coupled to a carrier; a first planetary gear set including a first ring gear operably coupled to the second traction ring assembly, a first planet carrier, and a first sun gear operably coupled to the first motor/generator; a second planetary gear set including a second ring gear operably coupled to the first sun gear, a second planet carrier coupled to the first planet carrier, and a second sun gear coupled to the first ring gear and to the second motor/generator.

In some embodiments, the powertrain further includes a one-way clutch coupled to the engine and the first traction ring assembly.

In some embodiments, the powertrain further includes a first clutch configured to selectively couple the first sun gear and the second ring gear.

In some embodiments, the powertrain further includes a second clutch configured to selectively couple the second ring gear to ground

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is used in the variator of FIG. 1.

FIG. 3 is an illustrative view of different tilt positions of the ball-type variator of FIG. 1.

FIG. 4 is a lever diagram depicting another hybrid powertrain having a ball planetary continuously variable transmission, two planetary gear sets, two motor-generators, and two clutches.

FIG. 5 is a table depicting operating modes of the hybrid powertrain of FIG. 4.

FIG. 6 is chart depicting component speeds as a function of vehicle speed during an input split mode.

FIG. 7 is chart depicting component speeds as a function of vehicle speed during a compound split mode.

FIG. 8 is chart depicting component speeds as a function of vehicle speed during a synchronous mode shift point.

FIG. 9 is chart depicting component speeds as a function of vehicle speed during a fixed ratio mode.

### DETAILED DESCRIPTION OF THE PREFERRED EMBODIMENTS

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed ratio of the hybrid vehicle design.

These fixed ratio designs have many disadvantages, for example the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed speed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that improve the efficiency of hybrid vehicles.

This powertrain relates to electric powertrain configurations and architectures that will be used in hybrid vehicles. The powertrain and/or drivetrain configurations use a ball planetary style continuously variable transmission, such as the VariGlide®, in order to couple power sources used in a hybrid vehicle, for example, combustion engines (internal or external), motors, generators, batteries, and gearing.

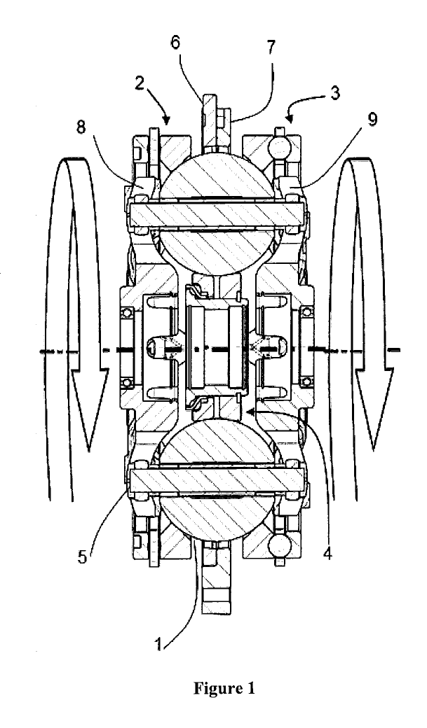

A typical ball planetary variator CVT design, such as that described in United States Patent Publication No. 2008/0121487 and in U.S. Pat. No. 8,469,856, both incorporated herein by reference in their entirety, represents a rolling traction drive system, transmitting forces between the input and output rolling surfaces through shearing of a thin fluid film. The technology is called Continuously Variable Planetary (CVP) due to its analogous operation to a planetary gear system. The system includes of an input disc (ring) driven by the power source, an output disc (ring) driving the CVP output, a set of balls fitted between these two discs and a central sun, as illustrated in FIG. 1. The balls are able to rotate around their own respective axle by the rotation of two carrier disks at each end of the set of balls axles. The system is also referred to as the Ball-Type Variator.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments. Furthermore, the embodiments include several novel features, no single one of which is solely responsible for its desirable attributes or which is essential to practicing the embodiments described.

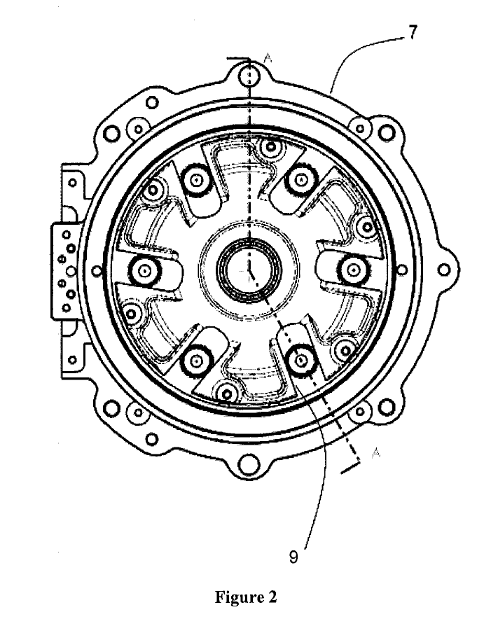

Provided herein are configurations of CVTs based on a ball-type variator, also known as CVP, for continuously variable planetary. Basic concepts of a ball-type Continuously Variable Transmissions are described in U.S. Pat. Nos. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input 2 and output 3, and an idler (sun) assembly 4 as shown on FIG. 1. Sometimes, the input ring 2 is referred to in illustrations and referred to in text by the label “R1”. The output ring is referred to in illustrations and referred to in text by the label “R2”. The idler (sun) assembly is referred to in illustrations and referred to in text by the label “S”. The balls are mounted on tiltable axles 5, themselves held in a carrier (stator, cage) assembly having a first carrier member 6 operably coupled to a second carrier member 7. Sometimes, the carrier assembly is denoted in illustrations and referred to in text by the label “C”. These labels are collectively referred to as nodes (“R1”, “R2”, “S”, “C”). The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In some embodiments, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. The embodiments disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,”, “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe the embodiments, specific structures or mechanisms that link or couple the elements are typically described. However, unless otherwise specifically stated, when one of said terms is used, the term indicates that the actual linkage or coupling is capable of taking a variety of forms, which in certain instances will be readily apparent to a person of ordinary skill in the relevant technology.

It should be noted that reference herein to “traction” does not exclude applications where the dominant or exclusive mode of power transfer is through “friction.” Without attempting to establish a categorical difference between traction and friction drives here, generally these will be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (p) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described here are capable of operating in both tractive and frictional applications. For example, in the embodiment where a CVT is used for a bicycle application, the CVT operates at times as a friction drive and at other times as a traction drive, depending on the torque and speed conditions present during operation.

Embodiments disclosed herein are directed to hybrid vehicle architectures and/or configurations that incorporate a CVP in place of a regular fixed ratio planetary leading to a continuously variable parallel hybrid. It should be appreciated that the embodiments disclosed herein are adapted to provide hybrid modes of operation that include, but are not limited to series, parallel, series-parallel, or EV (electric vehicle) modes. The core element of the power flow is a CVP, such as a VariGlide, which functions as a continuously variable transmission having four of nodes (R1, R2, C, and S), wherein the carrier (C) is grounded, the rings (R1 and R2) are available for output power, and the sun (S) providing a variable ratio, and, in some embodiments, an auxiliary drive system. The CVP enables the engine (ICE) and electric machines (motor/generators, among others) to run at an optimized overall efficiency. It should be noted that hydro-mechanical components such as hydromotors, pumps, accumulators, among others, are capable of being used in place of the electric machines indicated in the figures and accompanying textual description. Furthermore, it should be noted that embodiments of hybrid architectures disclosed herein incorporate a hybrid supervisory controller that chooses the path of highest efficiency from engine to wheel. Embodiments disclosed herein enable hybrid powertrains that are capable of operating at the best potential overall efficiency point in any mode and also provide torque variability, thereby leading to the optimal combination of powertrain performance and fuel efficiency. It should be understood that hybrid vehicles incorporating embodiments of the hybrid architectures disclosed herein are capable of including a number of other powertrain components, such as, but not limited to, high-voltage battery pack with a battery management system or ultracapacitor, on-board charger, DC-DC converters, a variety of sensors, actuators, and controllers, among others.

For purposes of description, schematics referred to as lever diagrams are used herein. A lever diagram, also known as a lever analogy diagram, is a translational-system representation of rotating parts for a planetary gear system. In certain embodiments, a lever diagram is provided as a visual aid in describing the functions of the transmission. In a lever diagram, a compound planetary gear set is often represented by a single vertical line (“lever”). The input, output, and reaction torques are represented by horizontal forces on the lever. The lever motion, relative to the reaction point, represents direction of rotational velocities. For example, a typical planetary gear set having a ring gear, a planet carrier, and a sun gear is represented by a vertical line having nodes “R” representing the ring gear, node “S” representing the sun gear, and node “C” representing the planet carrier.

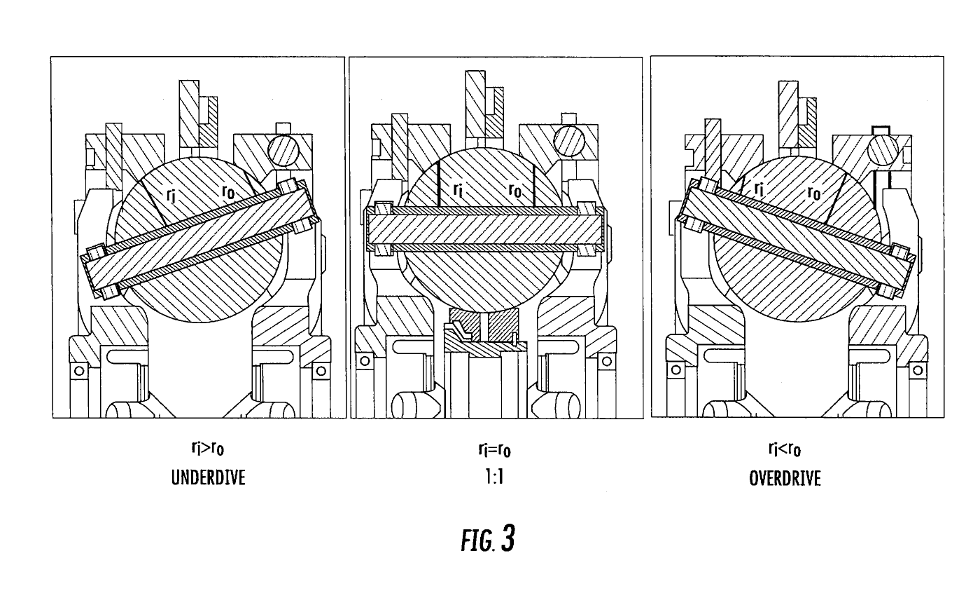

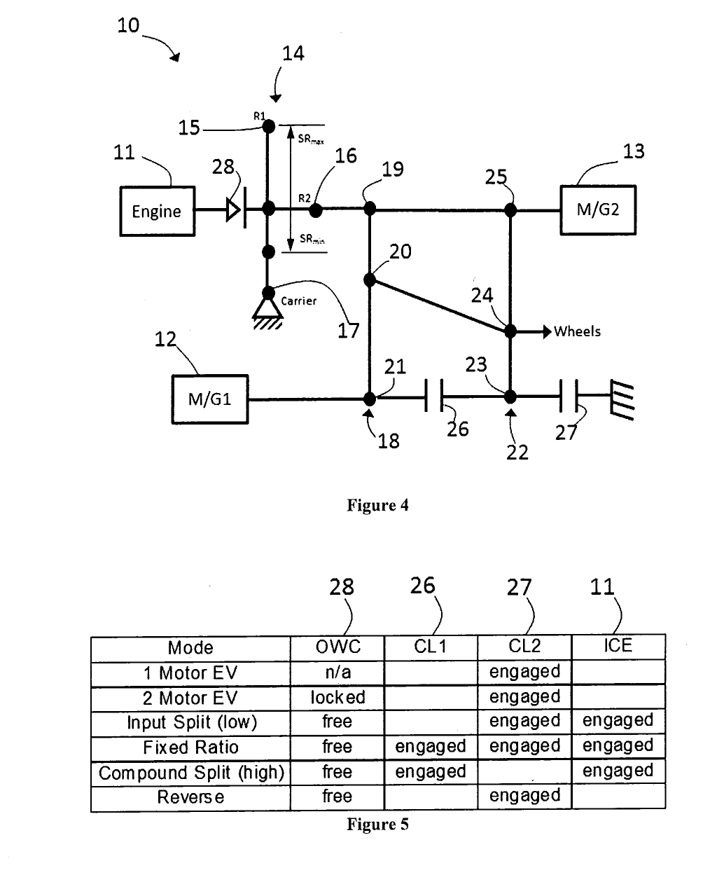

Referring to FIG. 4, in some embodiments, a hybrid powertrain 10 includes an engine 11, a first motor/generator 12, and a second motor/generator 13. In some embodiments, the hybrid powertrain 10 includes a variator (CVP) 14 that is similar to the variator described in FIGS. 1-3. The CVP 14 includes a first traction ring assembly 15 operably coupled to the engine 11, a second traction ring assembly 16, and a carrier assembly 17. The carrier assembly 17 is non-rotatable. In some embodiments, the hybrid powertrain 10 includes a first planetary gear set 18 having a first ring gear 19 coupled to the second traction ring assembly 16, a first planet carrier 20, and a first sun gear 21 coupled to the first motor/generator 12.

In some embodiments, the hybrid powertrain 10 includes a second planetary gear set 22 having a second ring gear 23 operably coupled to the first sun gear 21, a second planet carrier 24 coupled to the first planet carrier 20, and a second sun gear 25 coupled to the first ring gear 19 and coupled to the second motor/generator 13.

In some embodiments, the hybrid powertrain 10 includes a first clutch 26 configured to selectively couple the first sun gear 21 and the second ring gear 23. In some embodiments, the hybrid powertrain 10 includes a second clutch 27 configured to selectively couple the second ring gear 23 to a grounded member of the powertrain (not shown). In some embodiments, the hybrid powertrain 10 includes a one-way clutch 28 arranged to couple the engine 11 to the first traction ring assembly 15.

Turning now to FIGS. 5-9, during operation of the hybrid powertrain 10 multiple operating modes are achieved through the selective coupling of the first clutch 26, the second clutch 27, and the engagement of the engine 11 through the one-way clutch 28. For example, a single motor electric operating mode corresponds to an engaged second clutch 27 and a disengaged first clutch 26. A two motor electric operating mode corresponds to a locked one-way clutch 28, a disengaged first clutch 26, and an engaged second clutch 27. A low speed input split operating mode corresponds to a free one-way clutch 28 to engage engine 11, a disengaged first clutch 26, and an engaged second clutch 27. A fixed ratio operating mode corresponds to a free one-way clutch 28 to engage engine 11, an engaged first clutch 26, and an engaged second clutch 27. A high-speed compound split operating mode corresponds to a free one-way clutch 28 to engage engine 11, an engaged first clutch 26, and a disengaged second clutch 27. A reverse mode of operation corresponds to a disengaged engine 11, a disengaged first clutch 26, and an engaged second clutch 27.

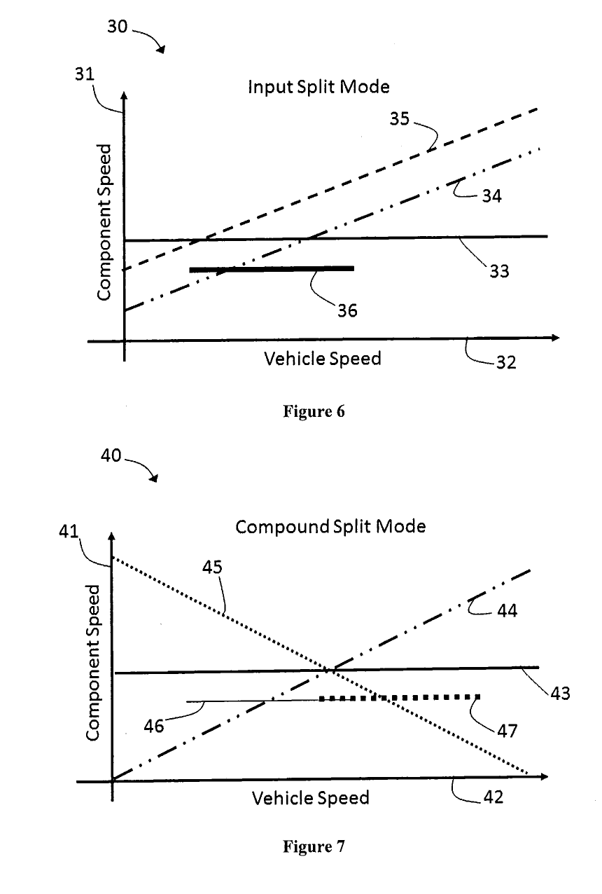

Referring now to FIG. 6, for description purposes, a chart 30 illustrates component speeds 31 with respect to a vehicle speed 32 during an input split operating mode. For illustrative purposes only, the speed of engine 11 is depicted as constant, while it is understood that this can vary in operation. For the input split operating mode, speed of the engine 11 is constant and depicted by a first line 33 on the chart 30. A speed of the first motor/generator 12 is depicted as a second line 34 on the chart 30. A speed of the second motor/generator 13 is depicted as a third line 35 on the chart 30. A mechanical point range 36 is depicted as a fourth line 36 on the chart 30.

In some embodiments, the ratio of the CVP 14 is controlled to provide a variable distribution of power between the engine 11, the first motor/generator 12, and the second motor/generator 13. For example, typical series-parallel hybrid powertrains having fixed ratio couplings between electric motors and the engine are adapted to operate in two modes. A first mode of operation is characterized as a series mode of operation where the engine is supplying power to an electric machine and the electric machine is thereby providing power to the driven wheels. A second mode of operation is characterized as a parallel mode of operation where the engine is supplying all of the power to the driven wheels at a point referred to as the mechanical point. In other words, the mechanical point for a hybrid powertrain is characterized by a non-zero vehicle speed, or non-zero transmission output speed, and a near zero electric machine speed. For example, series-parallel hybrid powertrains are often designed to provide a mechanical point near a typical highway cruising speed of the vehicle to provide the most efficient operation of the engine. For operation of the hybrid powertrain 10, the variable speed ratio of the CVP 14 provides a variable mechanical point.

Referring now to FIG. 7, for description purposes, a chart 40 illustrates component speeds 41 with respect to a vehicle speed 42 during a compound split operating mode. For illustrative purposes only, the speed of engine 11 is depicted as constant, while it is understood that this can vary in operation. For the compound split operating mode, speed of the engine 11 is constant and depicted by a first line 43 on the chart 40. A speed of the first motor/generator 12 is depicted as a second line 44 on the chart 40. A speed of the second motor/generator 13 is depicted as a third line 45 on the chart 40. A first mechanical point range is depicted as a fourth line 46 on the chart 40. A second mechanical point range is depicted as a fifth line 47 on the chart 40.

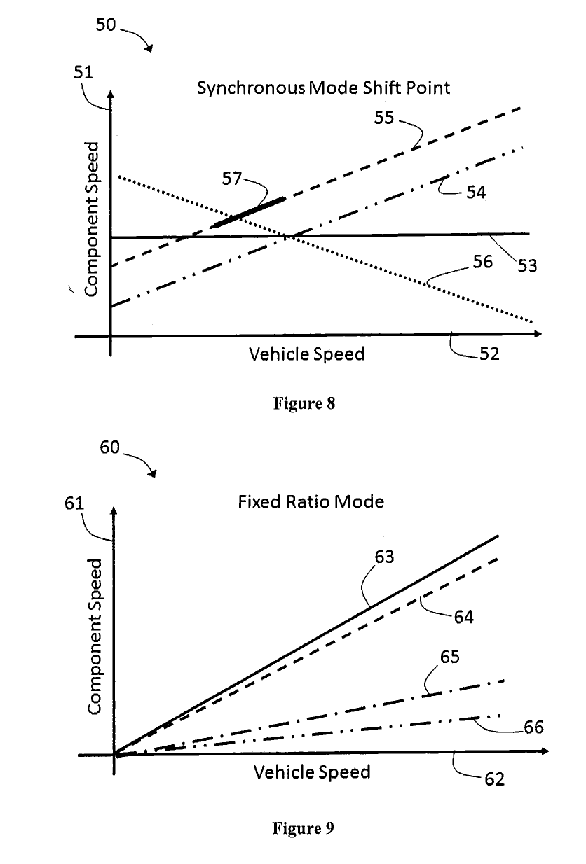

Referring now to FIG. 8, for description purposes, a chart 50 illustrates component speeds 51 with respect to a vehicle speed 52 during a synchronous mode shift between the input split operating mode and the compound split operating mode. For illustrative purposes only, the speed of engine 11 is depicted as constant, while it is understood that this can vary in operation. For the synchronous mode shift point, speed of the engine 11 is constant and depicted by a first line 53 on the chart 50. A speed of the first motor/generator 12 is depicted as a second line 54 on the chart 50. The input split speed of the second motor/generator 13 is depicted as a third line 55 on the chart 50. The compound split speed of the second motor/generator 13 is depicted as a fourth line 56 on the chart 50. A synchronous speed range is depicted as a fifth line 57 on the chart 50. In some embodiments, the fifth line 57 corresponds to the speed range of the second motor/generator 13 during a mode shift due to the variable ratio provided by the CVP 14.

Referring now to FIG. 9, for description purposes, a chart 60 illustrates component speeds 61 with respect to a vehicle speed 62 during a fixed ratio operating mode. For the fixed ratio operating mode, speed of the engine 11 with the CVP 14 set to unity is depicted by a first line 65 on the chart 60. A speed of the second motor/generator 13 is depicted as a second line 63 on the chart 60. A speed of the engine 11 with the CVP 14 set in underdrive is depicted as a third line 64 on the chart 60. A speed of the engine 11 with the CVP 14 set in overdrive is depicted as a fourth line 66 on the chart 60.

It should be understood that additional clutches/brakes, step ratios are optionally provided to the hybrid powertrains disclosed herein to obtain varying powerpath characteristics. It should be noted that, in some embodiments, two or more planetary gears and a variator are optionally configured to provide a desired speed ratio range and operating mode to the electric machines. It should be noted that the connections of the engine and the two electric machines to the powerpaths disclosed herein are provided for illustrative example and it is within a designer's means to couple the engine and electric machines to other components of the powertrains disclosed herein.

It should be noted that where an ICE is described, the ICE is capable of being an internal combustion engine (diesel, gasoline, hydrogen) or any powerplant such as a fuel cell system, or any hydraulic/pneumatic powerplant like an air-hybrid system. Along the same lines, the battery is capable of being not just a high voltage pack such as lithium ion or lead-acid batteries, but also ultracapacitors or other pneumatic/hydraulic systems such as accumulators, or other forms of energy storage systems. In some embodiments, the first and second motor-generators are capable of representing hydromotors actuated by variable displacement pumps, electric machines, or other forms of rotary power such as pneumatic motors driven by pneumatic pumps. The eCVT architectures depicted in the figures and described in text is capable of being extended to create a hydro-mechanical CVT architectures as well for hydraulic hybrid systems.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the embodiments, except in so far as any one claim makes a specified dimension, or range of thereof, a feature of the claim.

While preferred embodiments have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein are capable of being employed in practicing the invention. It is intended that the following claims define the scope of the invention and that methods and structures within the scope of these claims and their equivalents be covered thereby.

What is claimed is:

1. A powertrain comprising:
a first motor/generator;
a second motor/generator;
an engine;
a continuously variable planetary transmission (CVP) having a plurality of balls, each ball provided with a tiltable axis of rotation, each ball in contact with a first traction ring assembly and a second traction ring assembly, and each ball operably coupled to a carrier;
a first planetary gear set comprising a first ring gear operably coupled to the second traction ring assembly, a first planet carrier, and a first sun gear operably coupled to the first motor/generator; and
a second planetary gear set comprising a second ring gear operably coupled to the first sun gear, a second planet carrier coupled to the first planet carrier, and a second sun gear coupled to the first ring gear and to the second motor/generator.

2. The powertrain of claim 1, further comprising a one-way clutch coupled to the engine and the first traction ring assembly.

3. The powertrain of claim 1, further comprising a first clutch configured to selectively couple the first sun gear and the second ring gear.

4. The powertrain of claim 4, further comprising a second clutch configured to selectively couple the second ring gear to ground.
